(19) United States
(12) Patent Application Publication
(10) Pub. No.: US 2017/0092036 A1
(43) Pub. Date: Mar. 30, 2017

(54) KIOSK WITH PRINTER AND ROTATABLE SUPPORT

(71) Applicant: Carestream Health, Inc., Rochester, NY (US)

(72) Inventors: Curt A. Wiens, Woodbury, MN (US); James R. Gilbertson, Oakdale, MN (US)

(21) Appl. No.: 15/263,406

(22) Filed: Sep. 13, 2016

Related U.S. Application Data
(60) Provisional application No. 62/234,304, filed on Sep. 29, 2015.

(51) Int. Cl. G07F 17/26; H04N 1/00

(52) U.S. Cl. CPC G07F 17/266; H04N 1/00347; H04N 1/00559; H04N 2201/0079

(57) ABSTRACT

A medical self-service kiosk. The kiosk includes a housing, a display, a turntable, and a printer. The display is disposed on a front side of the housing for accepting instructions from a user. An output tray is configured as an opening on the front side of the housing to receive a print generated by the printer in response to an instruction from a user using the display. A panel, located on the front side of the housing, is moveable between a closed position and an open position to access the interior of the housing. The turntable and printer are disposed within the interior of the housing and are rotatable about an axis, such that a printer's supply area is accessible by a user when the panel is in the open position.

### CROSS REFERENCE TO RELATED APPLICATIONS

This application claims the benefit of U.S. Provisional application U.S. Ser. No. 62/234,304, provisionally filed on Sep. 29, 2015, entitled “KIOSK WITH PRINTER AND TURNTABLE”, in the name of Wiens et al, which is incorporated herein in its entirety.

### FIELD OF THE INVENTION

The invention relates generally to an unattended automated terminal or kiosk for use by a user. More particularly, the invention relates to a self-service kiosk for use by a user to obtain a medical image.

### BACKGROUND

Self service kiosks are well known for various industries, for example, to obtain cash, to perform an online transaction, or collect cash in exchange for merchandise. While such systems may have achieved certain degrees of success in their particular applications, there is a need for a self service kiosk for use by a patient to obtain medical records.

### SUMMARY

According to one aspect of the invention, there is provided a self-service kiosk, and more particularly, a self-service kiosk for medical applications.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a self-service kiosk in accordance with the present embodiments.

FIG. 2 shows a perspective view of a self-service kiosk in accordance with the present embodiments.

FIG. 3 shows a perspective view of the self-service kiosk of FIG. 1 with the panel in the open position.

FIG. 4A shows a turntable and printer in a horizontal configuration.

FIG. 4B shows a turntable and printer in a tilted/angled configuration.

4C shows a cross-section view of a kiosk including the turntable and printer at an approximate 15 degree tilt.

FIG. 5 shows an exemplary printer.

FIG. 6 shows an exemplary printer having a toner cartridge.

FIG. 7 shows a perspective view of the self-service kiosk of FIG. 3 with the panel in the open position and the printer's supply area in a loading position.

FIG. 8 shows a perspective view of the self-service kiosk of FIG. 3 with the panel in the open position and the printer's toner cartridge area in a loading position.

### DETAILED DESCRIPTION OF EXEMPLARY EMBODIMENTS

The following is a detailed description of the embodiments of the invention, reference being made to the drawings in which the same reference numerals identify the same elements of structure in each of the several figures.

In various situations, a user/patient may want to obtain a copy of a medical data or record, for example, a medical report or a medical x-ray image. In such a situation, a self service kiosk can include a printer configured to print the report and/or image.

Printers can print a report on paper or transparency, and are well known. Printers which can print medical x-ray images are also known, for example, Carestream DryView Laser Imager (models include 5950 and 6950).

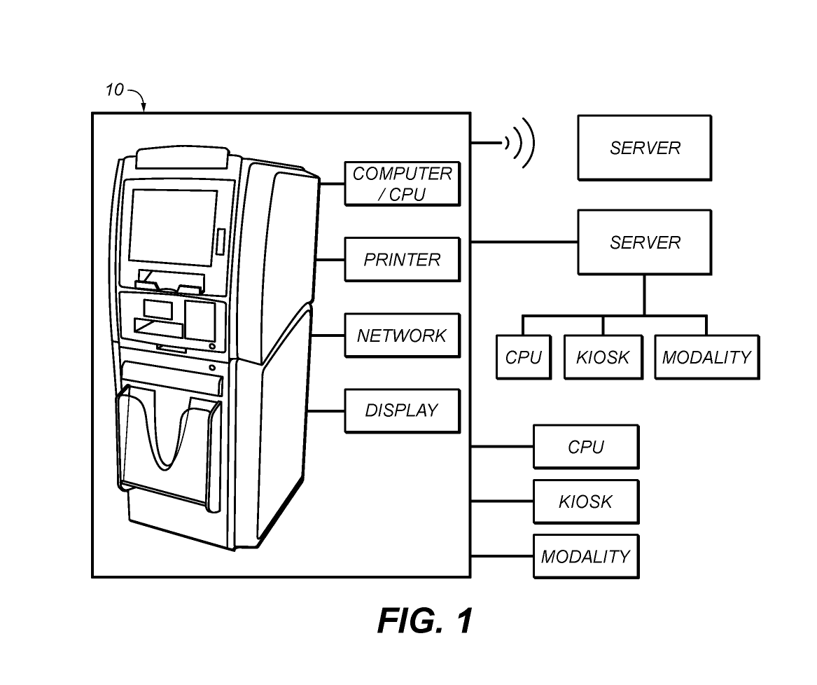

Referring to FIG. 1, there is shown a self-service kiosk 10 for use by a user/operator to obtain a print of medical data, including a report or image. The kiosk includes a printer and display.

Kiosk 10 can be a stand alone unit, or can include means to communicate with other devices. For example, kiosk 10 can include a CPU/computer or a communication device (wired or wireless technology) for access to a CPU/computer/server located remote from the kiosk to obtain/access medical data including records and images. Kiosk 10 can include a communication device (wired or wireless technology) to communicate with other devices to obtain/access medical data. These devices can include, for example, another kiosk, a medical modality (MRI, Computed Tomography, Cone Beam Computed Tomography, or the like), and/or a network server allowing access to other CPUs/computers/servers).

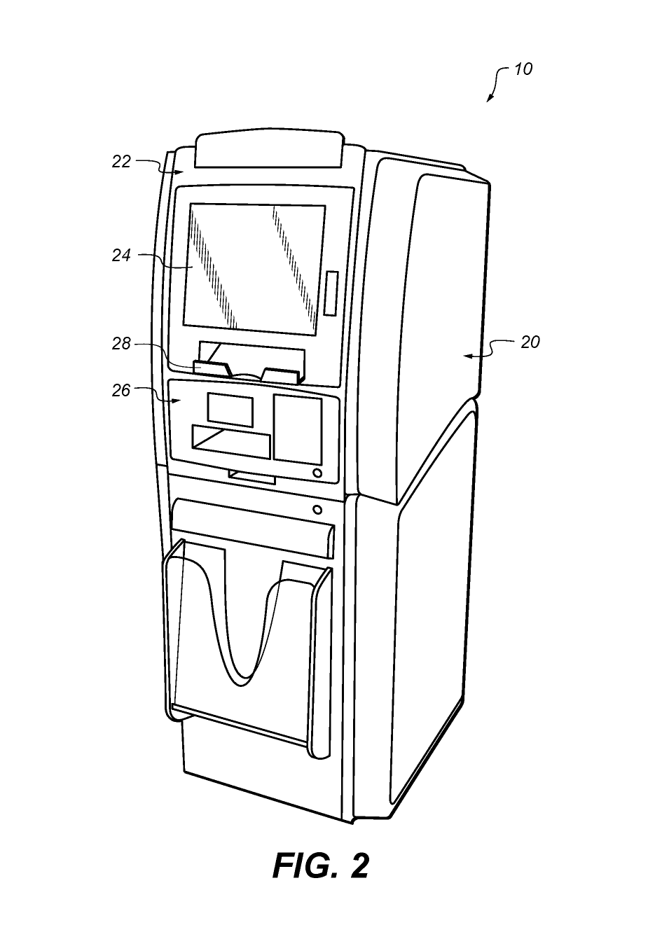

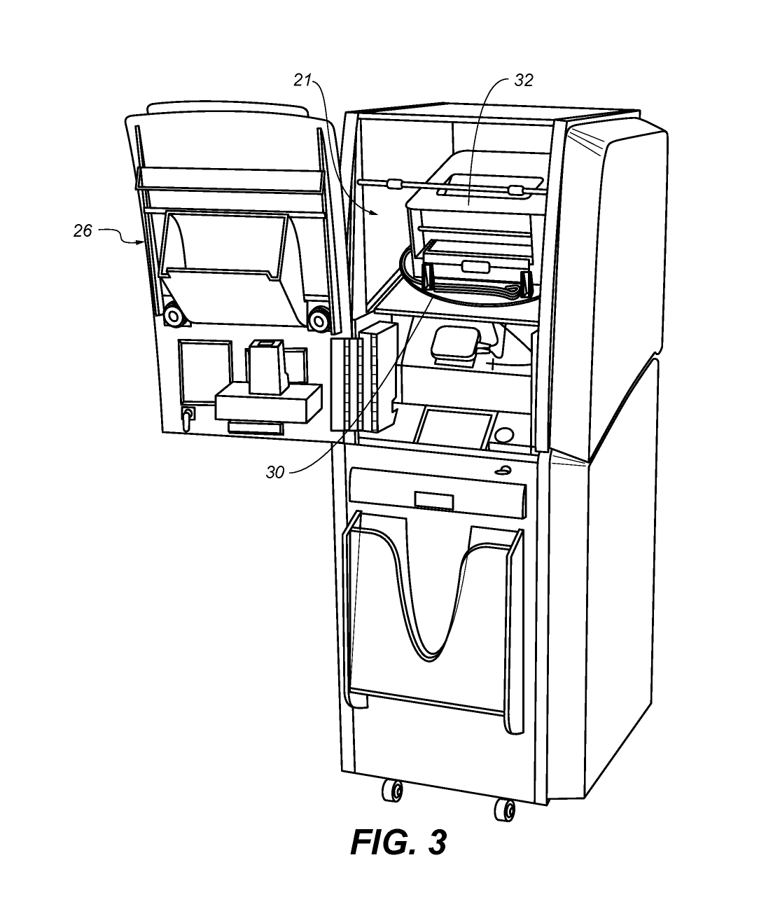

Referring to FIGS. 2 and 3, kiosk 10 is comprised of a housing 20 having an interior area 21 defined by a plurality of sides, a top, and a base. The housing includes a front side 22 supporting a display 24 for accepting instructions from a user.

Display 24 can be a touchscreen display and/or include other input devices such as a keyboard or mouse.

Front side 22 includes a panel 26 moveable relative to at least one side or base of the housing between a closed position and an open position. Note that while FIG. 3 shows panel 26 pivoting relative to a side of the housing, the movement of panel 26 can include other motions including being removable and/or slideable.

When panel 26 is in the closed position, the interior of the housing is not accessible by a user.

When panel 26 is in the open position, the user can access the interior of the housing.

Disposed within the interior of the housing is a support 30 and a printer 32. Printer 32 is disposed on a support 30 within the interior of the housing.

Front side 22 further includes a output tray 28 to receive prints generated by printer 32. As illustrated in the figures, output tray is a disposed on front side 22, and is configured as an opening on the front side of the housing and accessible when the panel is in the closed position. Output tray 28 receives a print generated by the printer in response to an instruction from a user using the display.

Support 30 is rotatable about an axis. Support 30 can be rotated about an axis by any amount, for example, between 1 degree and 360 degrees. In one arrangement, support 30 is rotatable by at least 180 degrees. In a preferred arrangement, support 30 is rotatable about an axis by between 270 and 360 degrees. Since support 30 is rotatable, it is also referred to herein as turntable 30.

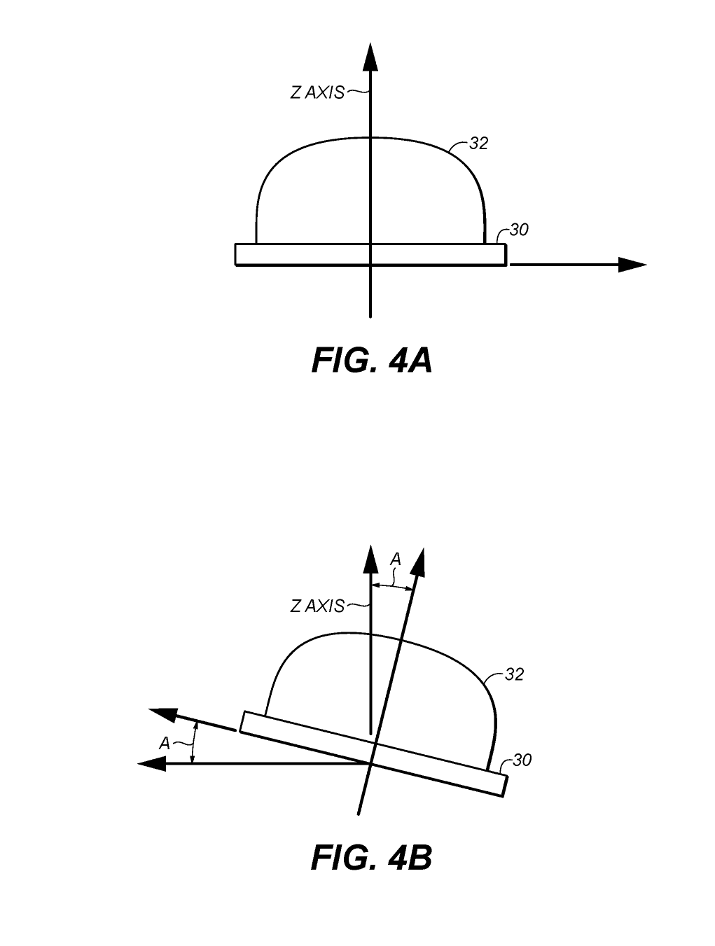

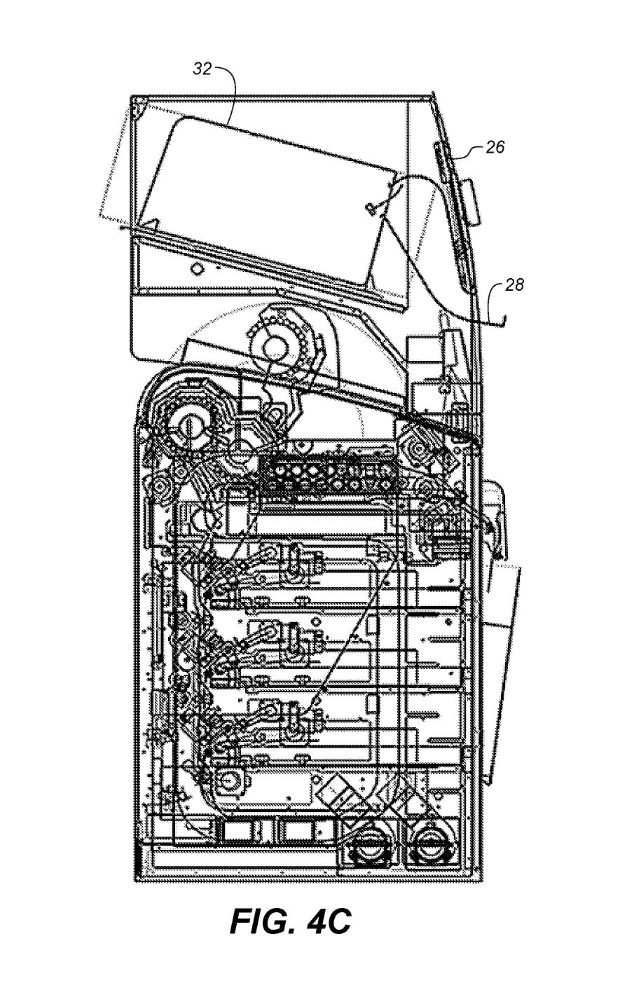

Referring to FIGS. 4A-4C, in one configuration, turntable 30 is configured to be substantially horizontal (i.e., substantially perpendicular to a vertical z-axis) relative to the base of the kiosk, while in other configurations, turntable 30 is tilted at an angle A relative to the vertical z-axis. The tilted/angled configuration may be desirable depending on the size and/or shape of the printer and interior. In at least one embodiment, angle A is preferably not greater than 20 degrees. For example, because of limited space for the paper/media to exit the front panel and because of user height considerations, turntable 30 is disposed at a 15 degree tilt/angle. FIG. 4C illustrates a cross-section view including the printer at an approximate 15 degree tilt.

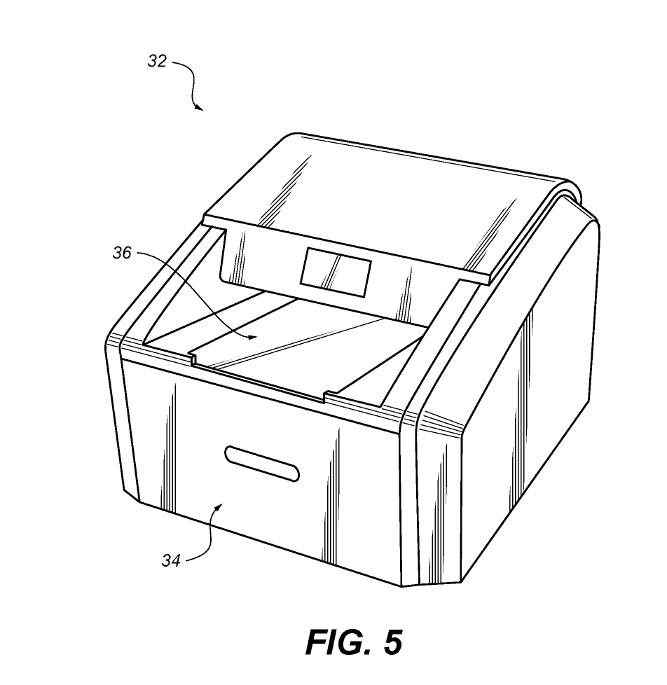

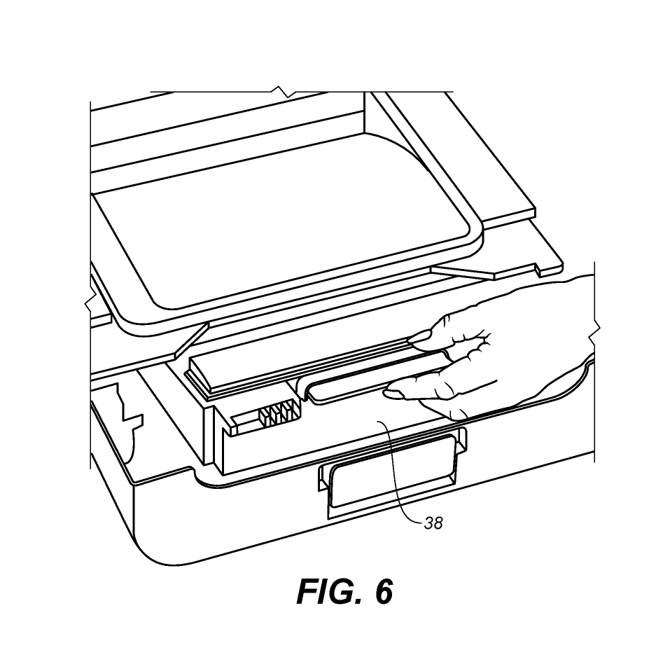

An example of a printer 32 for generating a medical x-ray image is the Carestream DryView laser imager, as illustrated in FIG. 5. Printer 32 has a supply area 34 and an output area 36. Other printers may also include a toner cartridge area 38, as illustrated in FIG. 6. Supply area 34 and output area 36 may be on the same or different or opposite sides of the printer. Likewise, the cartridge area 38 may be on the same or different or opposite sides of the printer.

During operation of the printer, the user may need to access the printer. For example, the user may need to input paper/media into supply area 34 or replace the toner cartridge in toner cartridge area 38. Accordingly, when panel 26 is in the open position, the user can access printer 32 disposed within the interior of the housing on turntable 30.

Further, by rotating turntable 30 to various positions, the user can access any and all sides of the printer, including the printer's supply area, output area, and/or toner cartridge area. This allows the user the ability to load paper/media in the supply area, access printouts in the output area, and replace toner in the toner cartridge area. These actions can be accomplished from the front of the unit. This arrangement minimizes floor space requirements and simplifies/improves access.

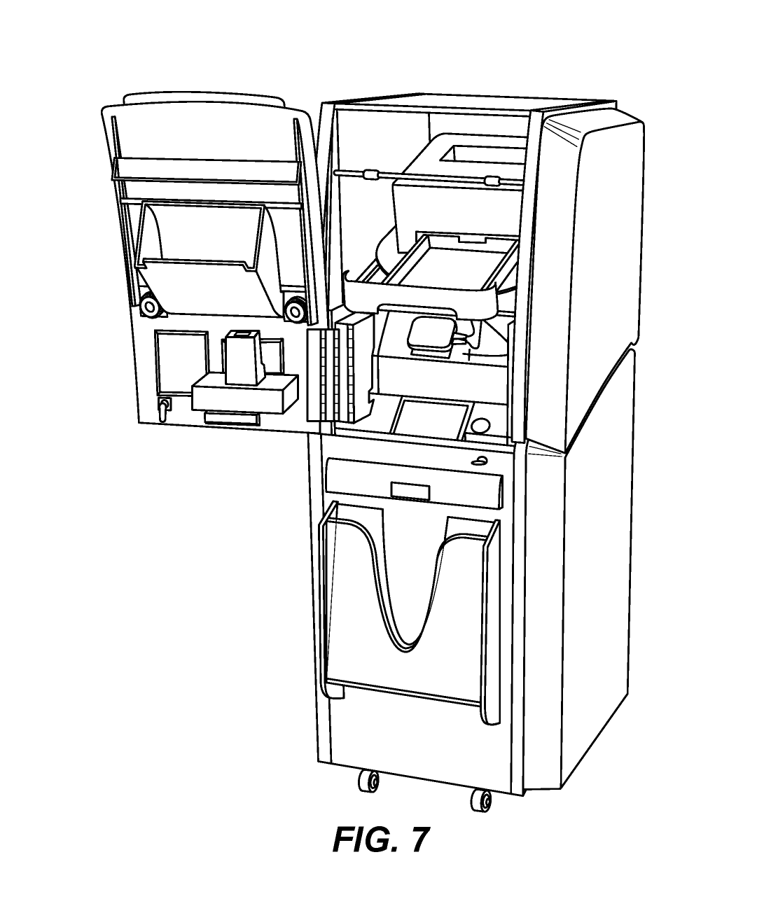

For example, a user can load paper/media from the front of the kiosk. This is accomplished by opening panel 26 to access interior 21, rotating turntable 30 until the printer's supply area is facing the front of kiosk 10. The supply area can then be accessed, for example, by opening the supply drawer, such as shown in FIG. 7.

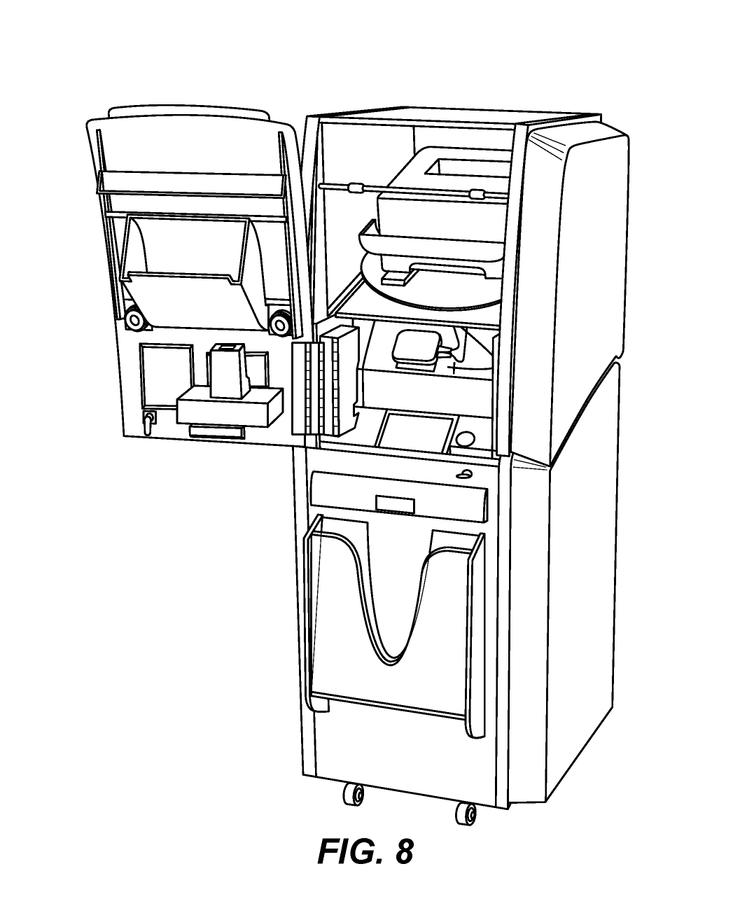

Similarly, a user can replace a toner cartridge for the printer from the front of the kiosk. This is accomplished by opening panel 26 to access interior 21, rotating turntable 30 until the printer's toner cartridge area is facing (or near) the front of kiosk 10. The toner cartridge area can then be accessed, for example, as shown in FIG. 8.

With the arrangement described, the user interacts with the kiosk using components located on the front side of the kiosk, including providing instructions (on the display) and obtaining a printout (from the output tray). Similarly, with the arrangement described, maintenance and operational aspects are conducted from the front side of the kiosk (opening the panel allows access to the interior).

Kiosk 10 can include a plurality of turntables and/or printers. For example, one turntable can support two stacked printers. Alternatively, two turntables can be employed, with each turntable supporting a printer.

Applicants have described a medical self-service kiosk. The kiosk includes a housing, a display, a turntable, and a printer. The housing defines an interior, and the housing includes a front side. The display is disposed on the front side for accepting instructions from a user. An output tray is configured as an opening on the front side, and is adapted to receive a print generated by the printer in response to an instruction from a user using the display. A panel, located on the front side, is moveable between a closed position and an open position to access the interior of the housing. The turntable is disposed within the interior of the housing and is rotatable by at least 180 degrees about an axis. The printer is disposed on the turntable within the interior of the housing; the printer includes a supply area and an output area, wherein the supply area is accessible by a user solely when the panel is in the open position.

In at least one arrangement, the turntable has a planar surface which is disposed at a non-zero angle relative to a horizontal surface. Preferably, the angle is less than 20 degrees.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A medical self-service kiosk, comprising:
a housing defining an interior, the housing having a front side;
a display disposed on the front side for accepting instructions from a user;
a panel, located on the front side, moveable between a closed position and an open position to allow the user access to the interior of the housing;
a support disposed within the interior of the housing and rotatable about an axis;
a printer disposed on the support, the printer having a supply area, the supply area accessible to the user when the panel is in the open position; and
a output tray, configured as an opening on the front side of the housing and accessible when the panel is in the closed position, adapted to receive a print generated by the printer in response to an instruction from the user using the display.

2. The kiosk of claim 1 wherein the support has a planar surface which is disposed at a non-zero angle relative to a base surface of the kiosk.

3. The kiosk of claim 2 wherein the angle is less than 20 degrees.

4. The kiosk of claim 1 wherein the printer further comprises a cartridge area.

5. The kiosk of claim 1 wherein the support is rotatable by about 180 degrees.

6. The kiosk of claim 1 wherein the support is rotatable by between about 270 and 360 degrees.

7. The kiosk of claim 1 further comprising at least two printers, wherein the at least two printers are stacked on each other on the support.

8. The kiosk of claim 1 further comprising two printers and two supports, wherein each of the two printers is disposed on one of the two supports.
